(19) United States
(12) Patent Application Publication
(10) Pub. No.: US 2013/0339410 A1
(43) Pub. Date: Dec. 19, 2013

(54) METHOD OF FRACTAL-BASED DATA DISTRIBUTION

(71) Applicant: Garett Engle, Palo Alto, CA (US)

(72) Inventor: Garett Engle, Palo Alto, CA (US)

(21) Appl. No.: 13/909,030

(22) Filed: Jun. 3, 2013

Related U.S. Application Data
(60) Provisional application No. 61/654,937, filed on Jun. 3, 2012.

(51) Int. Cl. G06F 17/10

(52) U.S. Cl. CPC G06F 17/10
USPC 708/200

(57) ABSTRACT

A reader is utilized to detect motion of a user's fingers when a user mimics a typing motion. The system can be used to define various key press states for particular finger positions and then monitor the motion of fingers to detect when a key state is entered. The system can then provide the detected key state as input to a system expecting the data input.

### CROSS-REFERENCE TO RELATED APPLICATIONS

This is a utility patent application being filed in the United States as a non-provisional application for patent under Title 35 U.S.C. §100 et seq. and 37 C.F.R. §1.53(b) and, claiming the benefit of the prior filing date under Title 35, U.S.C. §119(e) of the United States provisional application for patent that was filed on Jun. 3, 2012 and assigned Ser. No. 61/654,937, which application is incorporated herein by reference in its entirety.

### BACKGROUND

Knowledge is indeed power and, the lack of knowledge, in the information age in which we live, can be catastrophic. Information that is gathered, process, sorted, analyzed and stored is meaningless and useless, unless this information can be communicated. And, in many situations, the information does not just need to be communicated but rather, it needs to be communicated in an efficient manner that actually transfers knowledge along with the communication in a manner that is user centric.

One of the things that a person quickly realizes when studying the structure of this world in which we live, is that this world is incredibly created, organized and orderly. Carl Sagan described this world, when viewed from a picture taken by Voyager 1 spacecraft at a distance of 3.7 billion miles away just before it turned and headed out of the galaxy as the “pale blue dot”.

In his book, Sagan further describes this world as follows:

“look again at that dot. That's here. That's home. That's us. On it everyone you love, everyone you know, everyone you ever heard of, every human being who ever was, lived out their lives. The aggregate of our joy and suffering, thousands of confident religions, ideologies, and economic doctrines, every hunter and forager, every hero and coward, every creator and destroyer of civilization, every king and peasant, every young couple in love, every mother and father, hopeful child, inventor and explorer, every teacher of morals, every corrupt politician, every “superstar,” every “supreme leader,” every saint and sinner in the history of our species lived there-on a mote of dust suspended in a sunbeam.

Taking a close look at this world, the order in which we find it is quite amazing. One of the more fascinating realizations is how much of our world can be viewed as fractals. Fractal designs and patterns are found all throughout nature. From clouds, mountains, trees, the ocean waves, astronomical systems, etc. Many things in nature exhibit a fractal-based foundation including the human body and it's processes. Even computer systems, and the way information flows, demonstrates fractal properties (think the Internet and it's multi-dimensional layers of networks).

This natural phenomenon which occurs over and over again in nature can cause one to pause in thought. Could it be, that this mathematical phenomenon could be applied in a practical, novel manner to facilitate the delivery of information to others?

### SUMMARY OF THE INVENTION

The present disclosure presents methods and systems for enhancing the delivery of information based on an understanding of fractals. It is not hard to see how the method in which we distribute information to humans could be enhanced by basing the data distribution method upon a fractal-based algorithm. That is, to mold the human, data-distribution method to a system that is more aligned to our natural state or a state that recurs over and over again in nature: fractals. By being aligned to our natural state the data may be processed, integrated and/or absorbed with greater efficiency.

In general, various embodiments may include a system for distributing information in accordance with fractals. The system may include a fractal generator and a distributor. The fractal generator is configured to receive a seed that includes data to describe an initial state and information to identify the number of iterations, and then to generate a fractal map based on the seed and the number of iterations. The distributor is then configured to receive the fractal map and information pertaining to the data and, distributing the data in accordance with the fractal map to generate a data mapping. The generated data mapping is then used as input for controlling the distribution of the data.

As a non-limiting example examining television advertising, the well accepted theory is that the more you see an ad the more effective it is. However, such a conclusion may not be absolutely correct as an ad viewed too much, too frequently, etc., may generate a negative reaction to the product/brand or desensitize the viewer, thereby totally defeating the purpose of the ad in the first place (to create a positive association to the product/brand). Whereas the opposite extreme—showing an ad too little—is also ineffective simply because the ad is not viewed enough to have an impact.

Clearly a balance needs to be established with an ad's viewing frequency to optimize the absorption, retention and positive association with the ad. But the questions of the day are “what is this optimal viewing frequency? When do you show an ad versus give the user a break?

The present disclosure presents a novel technique for using fractal-based technology for generating a distribution pattern for data deliver, such as advertisements being delivered to a user base and then, distributing the advertisement in accordance with this pattern. As such a distribution is by nature, more in alignment with the processes of a human being—such a distribution may optimize the ad's intended goal.

Thus, various embodiments of a fractal-based information delivery system are presented, along with features, aspects, elements and functions of the same.

### BRIEF DESCRIPTION OF THE DRAWINGS

FIG. 1A, FIG. 1B and FIG. 1C illustrate a simple example of a fractal.

FIG. 2A, FIG. 2B and FIG. 2C illustrate another example of a fractal based on a tree structure or abstract nodes.

FIG. 3 is a fractal diagram illustrating the use of a fractal-based pattern for delivering advertisements to television viewers.

FIG. 4 is an illustration of the application of a fractal pattern to identifying locations for ads, such as billboards.

FIG. 5 is a functional block diagram of the components of an exemplary environment or system or sub-system implementing various aspects and/or embodiments of a fractal information distribution system.

FIG. 6A is a progressive drawing showing the operation of an exemplary fractal generator suitable for various embodiments of a fractal-based event assignor engine.

FIG. 6B is a drawing illustrating the operation of an exemplary event allocator suitable for use in various embodiments of the fractal-based event assignor engine.

FIG. 7 is a conceptual diagram of how the fractal generator example of FIG. 6A and the event allocator of FIG. 6B can be used in conjunction with the presentment of advertisements example.

FIG. 8 is a conceptual diagram of how the fractal generator example of FIG. 6A and the event allocator of FIG. 6B can be used in conjunction with the presentment of billboard advertisement example.

FIG. 9 is a block diagram showing the elements and information flow of an exemplary fractal-based event assignor engine.

### DETAILED DESCRIPTION OF THE DRAWINGS AND INVENTION

The present disclosure presents various embodiments, as well as feature, aspects and functions of such embodiments, of a fractal-based event assignor engine. In general, a fractal generator receives a seed or an initial input and, from such input generates a fractal mapping. An event assignor then receives event information and integrates it with the fractal mapping to generate an event mapping. As a result, any of a variety of scheduled events, activities, or other actions can be directed in accordance with a fractal-based schedule.

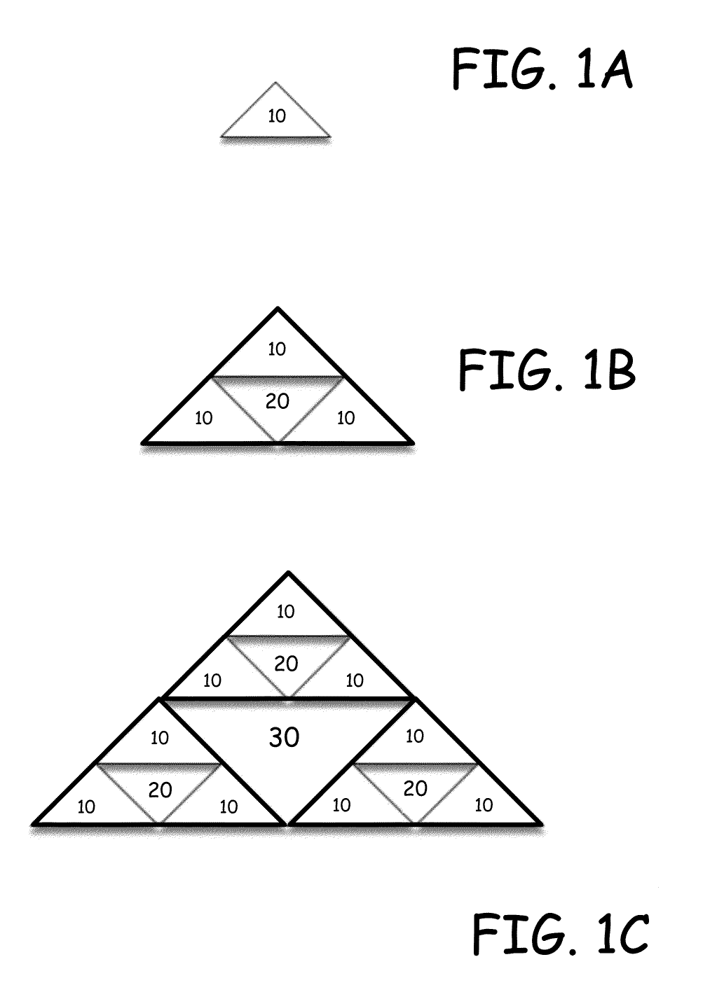

FIG. 1A, FIG. 1B and FIG. 1C illustrate a simple example of a fractal. FIG. 1A illustrates a simple triangle-object 10. The simple triangle-object 10 can be duplicated upon itself to create a slightly more complicated pattern 20 as illustrated in FIG. 1C. The algorithm, in this case, is to take the root object 10 and copy itself twice, placing one instance to the lower-left and the other instance to the lower-right of itself, giving us a new, fractal triangle-object 20. Next, this new pattern 20 can be used as input to the same algorithm used to transform root object 10 into fractal triangle-object 20 to result in a slightly more complicated, fractal triangle-object 30 as illustrated in FIG. 1C.

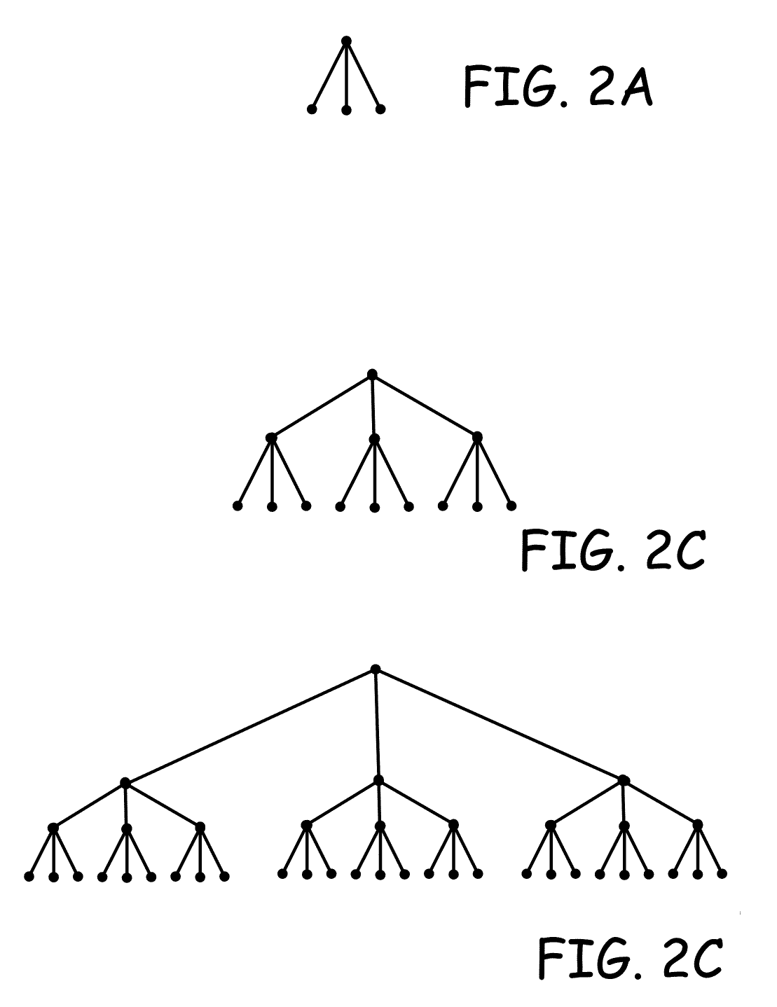

FIG. 2A, FIG. 2B and FIG. 2C illustrate another example of a fractal based on a tree structure or abstract nodes. It is clear that the same concept applies. Given a base object 40, applying the same algorithm discussed in conjunction with FIG. 1 to create a new node-object 50. Again, continuing the process another more complicated fractal node-object 60 can be created.

The purpose of demonstrating this node-based fractal object is that each node can easily refer to real-life implications that interface with humans. For example, each node may be a given timeslot for a television ad or the physical location of a set of billboards along a roadway.

By adjusting the fractal algorithm appropriately, the output pattern of an advertisement can be changed such that it is presented in accordance with a fractal structure. As a result, a balance is achieved between presenting the ad too frequently and, failing to present the ad frequently enough to make an impression. Throughout the present description, this balance will be referred to as an optimization of the desired action, such as the presentment of an ad. The optimization may result in the ad's retention and the generation of an association with the ad. Thus, the fractal algorithm and/or pattern used helps to contributes to an optimal impact of data distribution.

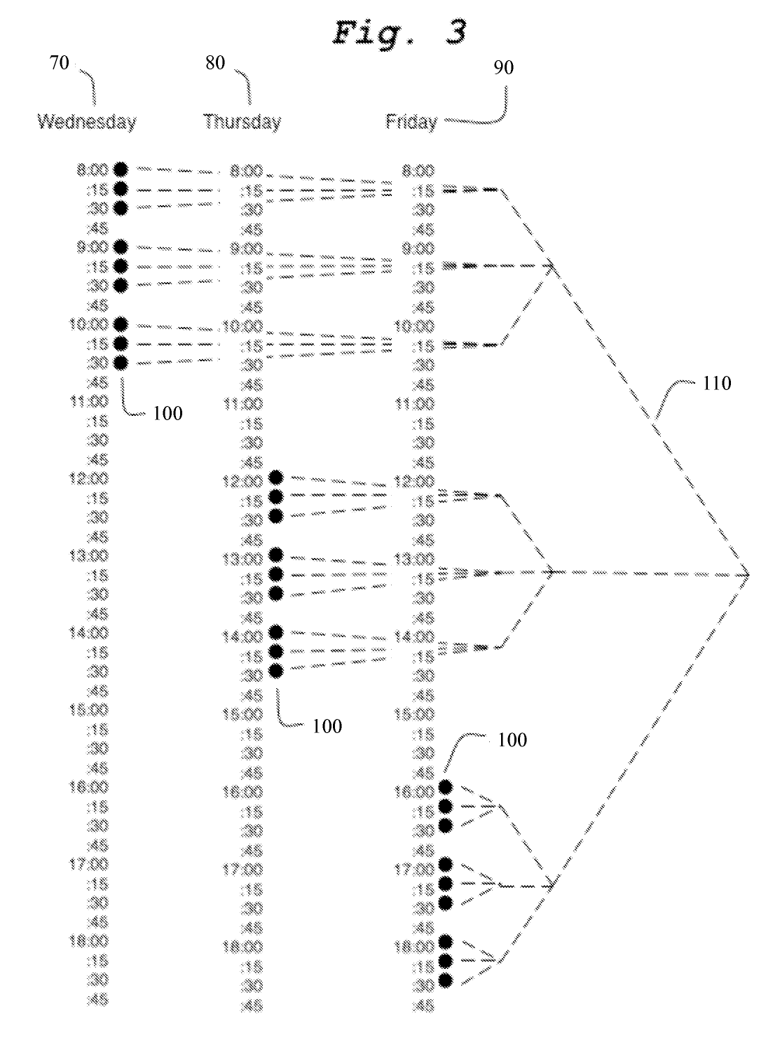

FIG. 3 is a fractal diagram illustrating the use of a fractal-based pattern for delivering advertisements to television viewers. The fractal pattern 110 that is employed in determining the appropriate time slots of ads to be displayed on television operates to optimize the ad presentment. Shown is an example of available time slots for ads to air on three days of the week: Wednesday 70, Thursday 80 and Friday 90. By applying a fractal algorithm to the ad display frequency 110, the time slot when a given ad should air across the three days given 100 can be determined. In other words, the end points 100 of the fractal algorithm 110 are the concluded time slots to air the ad.

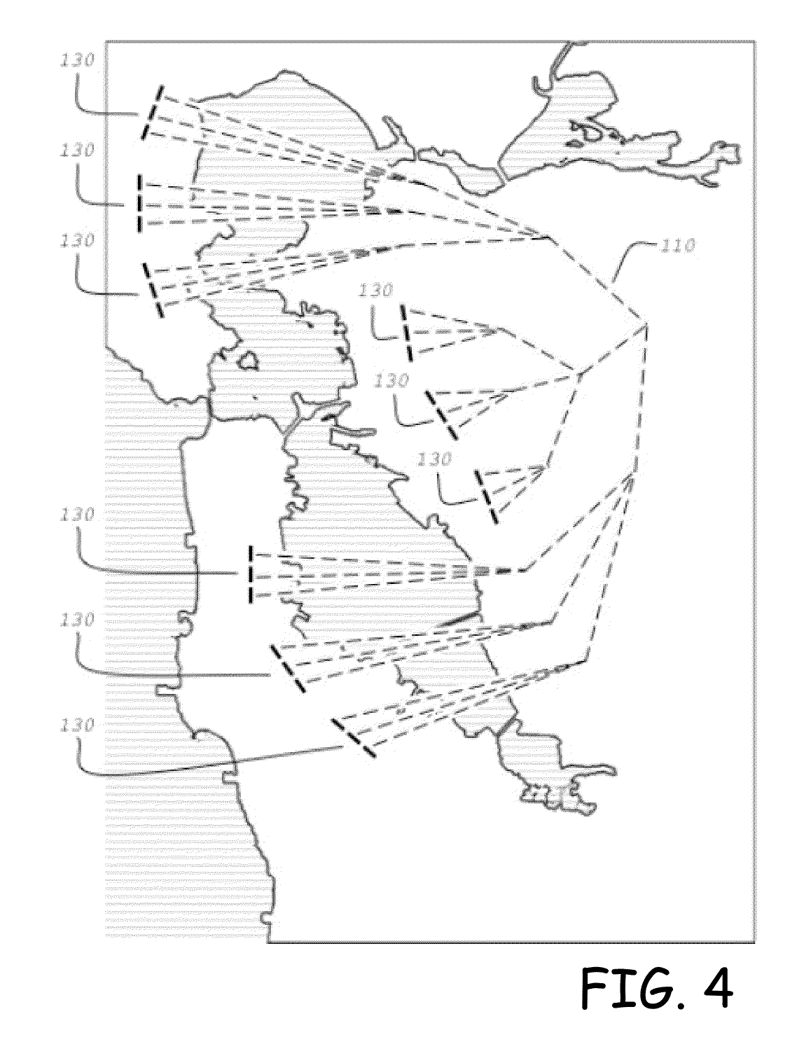

FIG. 4 is an illustration of the application of a fractal pattern to identifying locations for ads, such as billboards. A map of the San Francisco Bay Area is illustrated 120 with a fractal-based pattern overlaid on the Bay Area 120. An example is shown using a simple, fractal-based pattern 110 to determine appropriate locations of the same, similar or related billboards 130 along various roadways around the Bay Area 120 to optimize their advertising impact to a fractal distribution.

Embodiments of the fractal system can also be used for optimal memory retention, such as when learning new language. Key words may be displayed to the user based upon a fractal algorithm to maximize their understanding and retention.

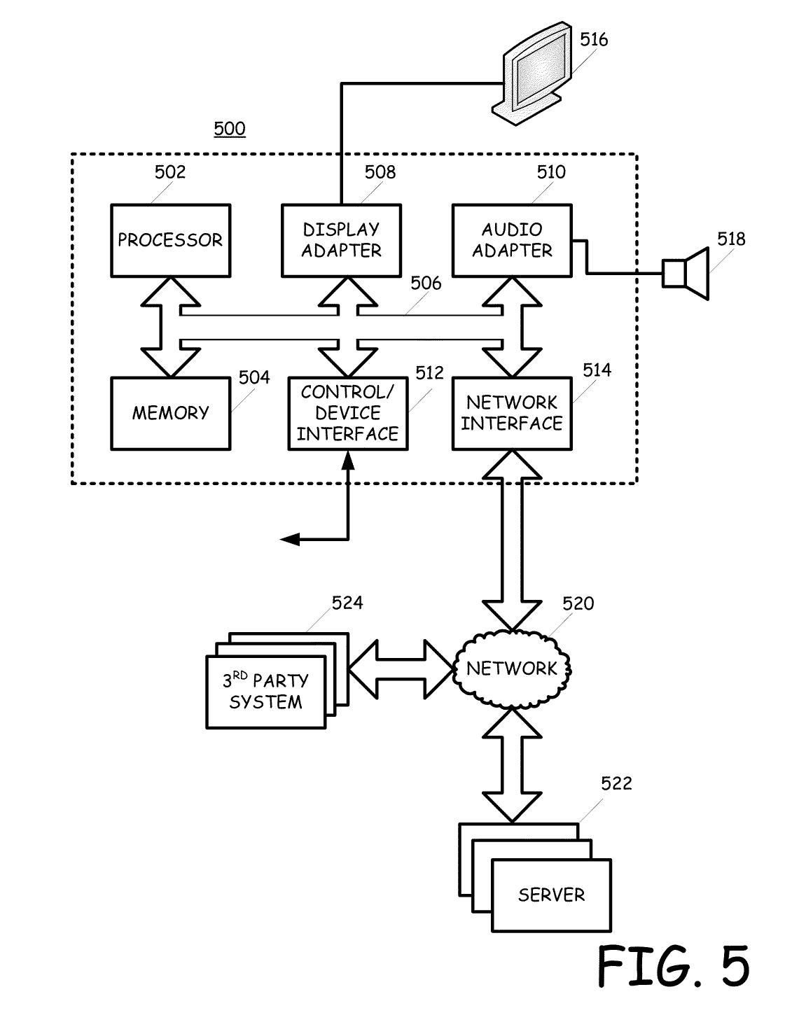

FIG. 5 is a functional block diagram of the components of an exemplary environment or system or sub-system implementing various aspects and/or embodiments of a fractal information distribution system. It will be appreciated that not all of the components illustrated in FIG. 5 are required in all embodiments of the fractal information distribution system but, each of the components are presented and described in conjunction with FIG. 5 to provide a complete and overall understanding of the components. The environment can include a general computing platform 500 illustrated as including a processor/memory device 502/504 that may be integrated with each other or, communicatively connected over a bus or similar interface 506. The processor 502 can be a variety of processor types including microprocessors, micro- controllers, programmable arrays, custom IC's etc. and may also include single or multiple processors with or without accelerators or the like. The memory element 504 may include a variety of structures, including but not limited to RAM, ROM, magnetic media, optical media, bubble memory, FLASH memory, EPROM, EEPROM, etc. The processor 502, or other components in the controller may also provide components such as a real-time clock, analog to digital convertors, digital to analog convertors, etc. The processor 502 also interfaces to a variety of elements including a control/device interface 512, a display adapter 508, an audio adapter 510, and network/device interface 514. The control/device interface 512 provides an interface to external controls, such as sensors, actuators, drawing heads, nozzles, cartridges, pressure actuators, leading mechanism, drums, step motors, cameras, a keyboard, a mouse, a pin pad, an audio activated device, as well as a variety of the many other available input and output devices or, another computer or processing device or the like. The display adapter 508 can be used to present a variety of information onto a display device, as well as provide other visual aspects of a user interface. An exemplary display device may include an LED display, LCD display, one or more LEDs or other display devices. The audio adapter 510 interfaces to and drives another sound producing element 518, such as a speaker or speaker system, buzzer, bell, etc. The network/interface 514 may interface to a network 520 which may be any type of network including, but not limited to the Internet, a global network, a wide area network, a local area network, a wired network, a wireless network or any other network type including hybrids. Through the network 520, or even directly, the controller 500 can interface to other devices or computing platforms such as one or more servers 522 and/or third party systems 524. A battery or power source provides power for the controller 500.

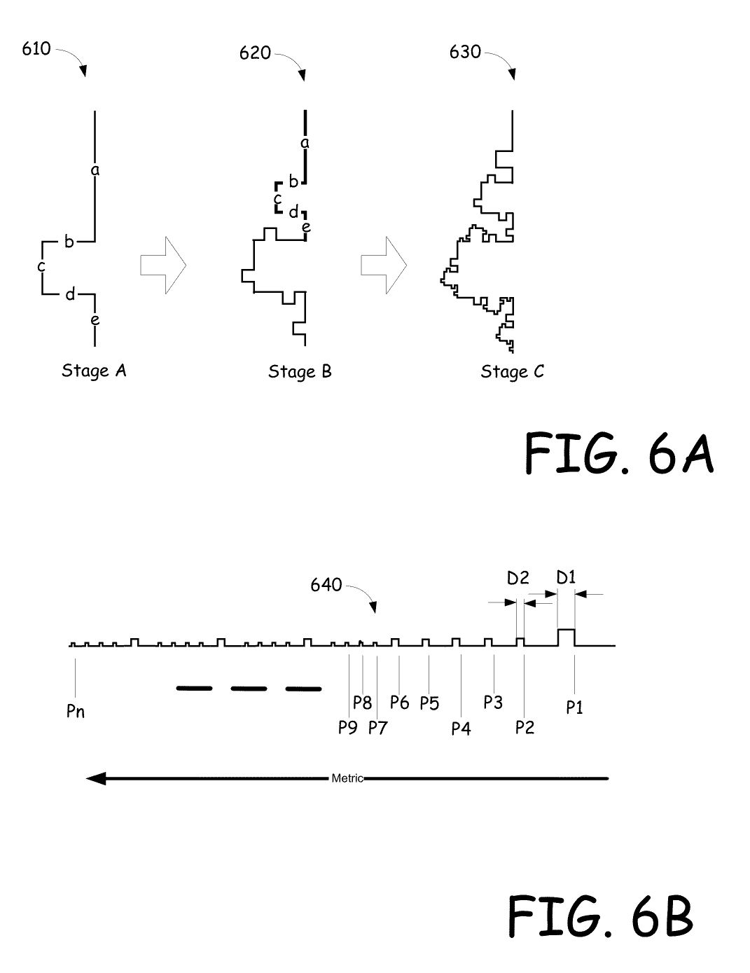

It will thus be appreciated that the present disclosure presents various embodiments of a system or engine for the assignment or mapping of real-world events, such as the presentment of an advertisement via electronic media, the placement of a billboard, as well as any of a wide variety of other actions and in general, the delivery of data, in accordance with a fractal based assignment. In general, various embodiments of a fractal-based event assignor engine can be described as including two functions: (1) a fractal generator and (2) a distributor, such as an event allocator. The fractal generator can be any of a variety of fractal generators that may take a particular or real-world seed or a generic seed, and generate an n-stage fractal representation. In addition, the event allocator maps elements or aspects of the final stage and/or interim stage fractals to events, actions or other real-world happenings. The operation of these two aspects of the various embodiments is best seen with reference to FIG. 6A and 6B.

FIG. 6A is a progressive drawing showing the operation of an exemplary fractal generator suitable for various embodiments of a fractal-based event assignor engine. In the illustrated example, an exemplary seed 610 and the results of two iterations of the fractal engine are shown. At stage A, the seed 610 is shown as including five line segments a, b, c, d and e to create the overall geometric shape of the seed 610. At stage B, the first iteration of the fractal generator replicates, for each line segment in seed 610, the entire geometric shape of seed 610. Thus, the first line segment “a” in seed 610, is replaced by a replication of lines segments a, b, c, d and e (as shown in bold for stage B) to create the first portion of the fractal iteration 620. This replication process is repeated for each line segment in stage B to create fractal iteration 620. Next, in stage C, the process is again repeated for each of the line segments in fractal iteration 620 to create the next stage C fractal iteration 630. Obviously, many stages can be included in any fractal generation process and the use of only three stages in the non-limiting example is for purposes of illustration and should in no way limit the scope of the disclosure.

FIG. 6B is a drawing illustrating the operation of an exemplary event allocator suitable for use in various embodiments of the fractal-based event assignor engine. In the illustrated example, the final iteration of the fractal 630 from FIG. 6A is shown as being laid out in a single line. The pulse or “bump” created by line segments b-c-d in the original seed 610, after the fractal generations, are illustrated as pulses along the laid out fractal 640. Moving from right to left and assuming that the line represents the progression through some metric, such as time, distance, etc., a first pulse appears at P1, a second at P2, a third at P3, etc. and ending at pulse Pn. As an non-limiting example, the event allocator can assign each of the pulses to correspond with the occurrence of an event. Thus, if the event allocator assigns an event to occur at each pulse, it is evident that the generated fractal serves as the basis for the allocation and assignment of events.

In addition, the pulse P1 is shown as having a duration of D1 and pulse P2 has a duration of D2. In various embodiments, the event allocator may operate to not only assign events to occur at particular times but also to have the duration, intensity or other elements of the event tied to the duration of the illustrated pulse, which is also in conformity to a fractal generation.

FIG. 6A and 6B can then be viewed in conjunction with the previously presented examples: presentment of advertisements FIG. 3 and location of billboards FIG. 4.

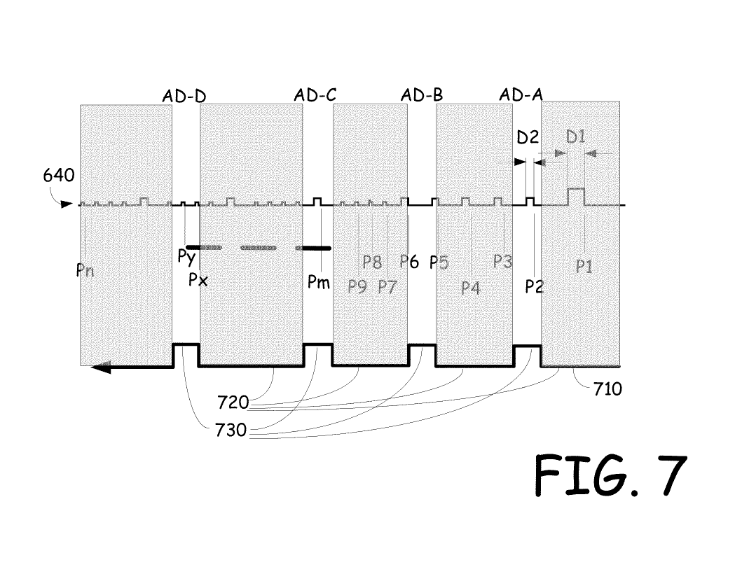

FIG. 7 is a conceptual diagram of how the fractal generator example of FIG. 6A and the event allocator of FIG. 6B can be used in conjunction with the presentment of advertisements example. In the illustrated non-limiting example, the time line 710 illustrates the time-line for a typical television station with the peaks or pulses 730 representing times during which advertisements can be displayed and the lower portions of the time-line 720 representing times at which program content is presented. In the presentment of advertisement example, the event allocator may cause the advertisements to be presented at each advertising segment 730 that corresponds with an event pulse from the fractal 640. As such, in the illustrated example, an advertisement would be presented at the advertising slot that coincides with the pulse P2 (AD-A), at the advertising slot that coincides with pulse P6 (AD-B), at the advertising slot that coincides with pulse Pm (AD-C), and the ad will be presented twice during the advertising slot that corresponds with pulses Px and Py (AD-C).

The event allocator could use other algorithms as well. For instance, each advertising slot could be sequentially numbered and the fractal line 640 could represent each of the advertising slots. For instance, the time before pulse P1 could represent the first four slots and pulse P1 could represent the next two slots. The time after P1 could represent the next four slots and pulse P2 could represent the next slot after this. In such an embodiment, any slots that coincide with the pulses would then be used to present the advertisement.

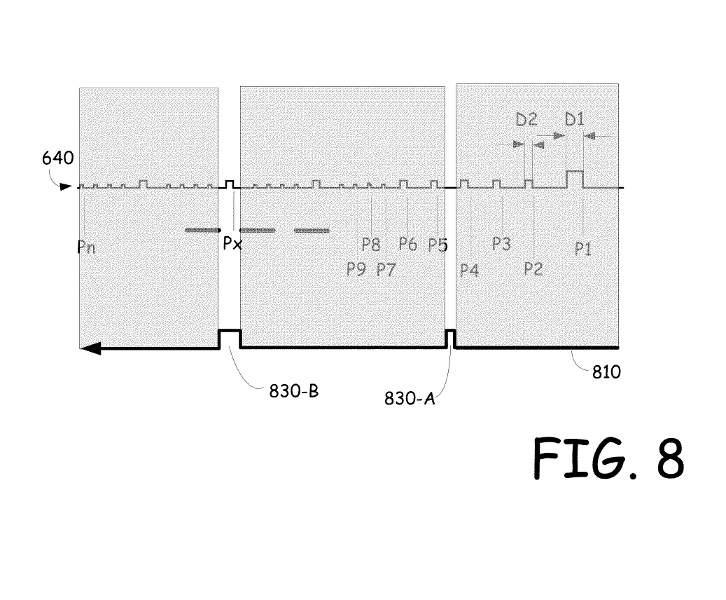

FIG. 8 is a conceptual diagram illustrating how the fractal generator example of FIG. 6A and the event allocator of FIG. 6B can be used in conjunction with the presentment of billboard advertisement example. In the illustrated example, line 810 represents the geographic distribution of billboards along a particular route. For example, the line 810 may represent the miles along a particular route and for each pulse, such as pulse 830-A, one billboard space is located over the represented area. Similarly, at pulse 830-B, billboard space is also available. Viewed in conjunction with the fractal line 640, at location 830-A, there is no corresponding pulse on the fractal line and as such, no advertisements will be displayed. However, at location 830-B, pulse Px in the fractal 640 appears and as such, an advertisement will be displayed on a billboard at that location.

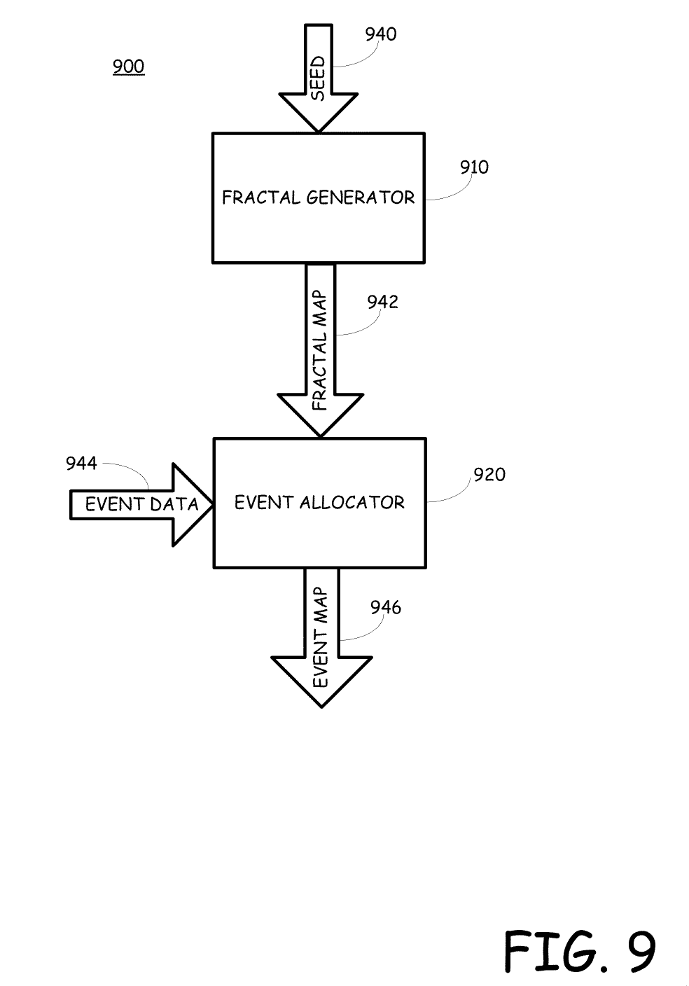

FIG. 9 is a block diagram showing the elements and information flow of an exemplary fractal-based event assignor engine. The illustrated engine 900 includes a fractal generator 910 and an event allocator 920. Initially, a seed 940 is fed into the fractal generator to initialize or set up the type of fractal to be generated. The seed 940 may also include information to identify the number of iterations that the fractal generator is to execute. The seed 940 may also include information identifying a portion of the seed that is to be treated as a point of interest or, a point to which the event allocator may assign the occurrence of an event. For instance, in the embodiment illustrated in FIG. 6A, the seed 940 may include information that identifies the original geographic shape consisting of line segments a, b, c, d and e, information to instruct the fractal generator to conduct two iterations and finally, information to indicate that line segment c is the point of interest or, the point that events will be assigned in the final fractal output.

Upon completion of all iterations, the fractal generator 910 outputs a fractal map 942. As an example, FIG. 6B could be considered a fractal map and the output of the fractal map 942 may include information sufficient to describe such output to a level sufficient enough for the event allocator 920 to process.

The event allocator 920 receives the fractal map 942 as well as event data 944 as input. The event allocator then processes the fractal map 942 in view of the event data 944 to generate an event map 946. As illustrated in FIG. 6A and FIG. 7, the seed 610 is fed into the fractal generator 910 to generate the fractal mapping 640 of FIG. 6B. The event data identifies a timeline of advertising slots and content slots. The event allocator 920 overlays the fractal map 640 and the timeline 710 to create an event map, which as presented in FIG. 7 includes slots AD-A, AD-B, AD-C and AD-D in which ads are presented. In the illustrated example, an ad is presented in each time slot except for AD-D in which the ad is presented twice.

Similarly, looking at FIG. 8, the event mapping includes information to indicate that at location 830-A, no billboard is presented but at location 830-B, a billboard is presented.

It will be appreciated that the generator may be any of a variety of fractal generators starting with any of a variety of seeds. The generators and the seeds may be selected based on the particular application with which the event allocator is operating, and as such, the fractal generated may be suitable to the particular application.

Thus, the various embodiments may work with any number of fractal algorithms and/or patterns that may be used to determine the end-points, or output, of the method.

The fractal algorithm and/or pattern output may be mixed with other relevant information to optimize the final results. For example, given the need to find optimal time-slot positions for a television ad, the prime-time hours of viewing may be considered or various holidays may influence the desired output to maximize potential impact. The output of the fractal pattern may be applied to many mediums. For example, the time-based output (television ads) and location-based output (billboards along a highway) or order-based output (the correct order to display a given word in learning a new language) are non-limiting examples of mediums. Other mediums may be possible—as long as there is an interface to distribute data to a human for maximum absorption and/or retention, or to a machine for implementation, this method may be applied.

Furthermore, the various embodiments may not be limited to human interaction. Any learning system—such as a neural network software program—may benefit from this method as well.

Thus, it will be appreciated that the various embodiments of a fractal-based event assignor engine can work in a variety of manners. The fractal generator may receive a seed or may start from a random or any initial state. A fractal generator creates a fractal map that can be used as input to control or guide the occurrence of various events or other activity. In essence, some embodiments operate to generate a schedule for controlling various activities and/or machines. For instance, in the advertisement example, the output event map may be directly fed into a processing system that selects and presents advertisement over a broadcast channel. Those skilled in the art will appreciate other applications of the various embodiments and the present disclosure anticipates such applications. Although the examples have been presented as event or action oriented, those skilled in the art will appreciate that the presented embodiments can operate to distribute a wide variety of elements such as data, ads, events, etc.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A system for distributing information in accordance with fractals, the system comprising:
a fractal generator configured to generate a fractal map;
a distributor configured to receive the fractal map and information pertaining to the data and, distributing the data in accordance with the fractal map to generate a data mapping; and
the data mapping be used as input for controlling the distribution of the data.

2. The system of claim 1, wherein the fractal generator receives a seed.

3. The system of claim 2, wherein the fractal generator generates x iterations of the fractal based on information received by the fractal generator.

4. The system of claim 3, wherein the fractal map represents a series of action points based on the structure of the fractal.

5. The system of claim 1, wherein the distributor receives information pertaining to the data by receiving scheduling information for an event.

6. The system of claim 5, wherein the distributor assigns occurrences of the event based on the fractal map.

7. The system of claim 5, wherein the fractal generator receives a seed.

8. The system of claim 7, wherein the fractal generator generates x iterations of the fractal based on information received by the fractal generator.

9. The system of claim 8, wherein the fractal map represents a series of action points based on the structure of the fractal.

10. The system of claim 9, wherein the distributor assigns occurrences of the event based on the action points in the fractal map.

11. A system for distributing information in accordance with fractals, the system comprising:
a fractal generator configured to receive a seed that includes data to describe an initial state and information to identify the number of iterations, and then to generate a fractal map based on the seed and the number of iterations;
a distributor configured to receive the fractal map and information pertaining to the data and, distributing the data in accordance with the fractal map to generate a data mapping; and
the data mapping be used as input for controlling the distribution of the data.

12. The system of claim 11, wherein the information received by the distributor identifies a time line indicating times at which events may occur and times at which events may not occur and, the fractal map identifies times at which events may occur and, the distributor is further configured to overlay the information to identify times at which the event will occur.

13. The system of claim 12, wherein the information received by the distributor identifies timeslots in which advertisements can be presented.

14. The system of claim 11, wherein the information received by the distributor identifies a geographic oriented line indicating locations at which events may occur and locations at which events may not occur and, the fractal map identifies locations at which events may occur and, the distributor is further configured to overlay the information to identify locations at which the event will occur.

15. The system of claim 14, wherein the information received by the distributor identifies locations at which billboards are displayed and the fractal map identifies billboards on which an advertisement is to be placed.
